(19) United States
(12) Patent Application Publication
(10) Pub. No.: US 2020/0408464 A1
(43) Pub. Date: Dec. 31, 2020

(54) APPARATUS AND METHODS FOR DRYING A SHEET OF MATERIAL

(71) Applicant: CORNING INCORPORATED, CORNING, NY (US)

(72) Inventors: Hironori Fukuyama, Iwata city, Shizuoka (JP); Hiroyuki Kamei, Fukuroi city, Shizuoka (JP); Hsi-Ta Lin, Changhua City, Changhua County (TW); Weiwei Luo, Painted Post, NY (US); Elias Panides, Horseheads, NY (US); Jingru Zhang Benner, Enfield, CT (US)

(21) Appl. No.: 16/976,264

(22) PCT Filed: Feb. 26, 2019
(86) PCT No.: PCT/US2019/019527

§ 371 Date: Aug. 27, 2020

Related U.S. Application Data
(60) Provisional application No. 62/635,593, filed on Feb. 27, 2018.

(51) Int. Cl. F26B 15/00; F26B 5/00; F26B 21/00

(52) U.S. Cl. CPC F26B 15/00; F26B 2015/003; F26B 21/004; F26B 5/00

(57) ABSTRACT

An air knife for discharging a stream of gas onto a sheet of material. The air knife includes a main body including an inlet portion and an outlet portion, and a plurality of inlet ports. The inlet portion defines a plenum. The outlet portion defines an exit orifice in fluid communication with the plenum. The inlet ports project from the inlet portion and each inlet port comprises a passageway in fluid communication with the plenum. In some embodiments, the inlet ports project from a rear, or trailing, wall of the main body. In other embodiments, the outlet portion terminates at an exit face in which the exit orifice is formed, with a tip region of the outlet portion forming a taper angle of not more than 90 degrees in extension to the exit face.

### CROSS-REFERENCE TO RELATED APPLICATIONS

This application claims the benefit of priority of U.S. Provisional Application Ser. No. 62/635,593 filed on Feb. 27, 2018 the contents of which are relied upon and incorporated herein by reference in their entirety as if fully set forth below.

### BACKGROUND

### Field

The present disclosure generally relates to apparatus and methods for processing a sheet of material, and more particularly, to air knife structures and drying apparatus for processing a substrate sheet, such as drying a glass sheet as part of a finishing operation.

### Technical Background

Processing glass sheets that require a high-quality surface finish like the ones used in flat panel displays typically involves cutting the glass sheet into a predetermined shape and then grinding and/or polishing the edges of the cut glass sheet to remove sharp edges and/or corners. Grinding and/or polishing steps may, for example, be carried out by a finishing apparatus that includes at least a finishing member (e.g., an abrasive wheel such as a grinding wheel, polishing wheel, etc.). Such finishing typically leaves debris on the major surfaces of the glass that should be removed, for example by flushing the glass sheet with a cleaning liquid, such as water. Debris, particularly glass debris, left on the surfaces of the glass sheet can bond to the surfaces and become difficult to remove. However, the cleaning liquid can leave spots (e.g., residue) if not quickly removed. Accordingly, drying apparatus are employed to remove the cleaning liquid. These drying apparatus should be capable of quickly eliminating the cleaning liquid across an entire surface of the glass sheet while the glass sheet is moved along by a conveyance apparatus.

As glass sheets, particularly glass sheets for use in electronic display devices, become dimensionally larger, the ability to provide substantially uniform removal of the cleaning liquid across an entire dimension of the sheet in a short amount of time becomes more difficult.

### SUMMARY

After a finishing process, for example an edge grinding process, a cleaning operation can be performed to remove contamination from the glass sheet surfaces. For example, the glass sheet can be conveyed through a wet cleaning station at which a solution of deionized water and a detergent (or other liquid solution) is applied to the glass sheet to remove surface particles and stains. Following the wet cleaning step, the glass sheet surfaces can then be dried, for example to prepare the glass sheet for inspection. The finishing (e.g., cutting, grinding, polishing, etc.), cleaning, and drying steps may be performed in-line, with the glass sheet continuously conveyed through various stations collectively referred to as a finishing line. Subsequent processing steps can include packing and shipping the glass sheet to customers or moving the glass sheet into a warehouse for storage.

The drying step is typically accomplished by transporting the glass sheet through a drying station at which one or more “air knives” direct pressurized gas (e.g., air) onto one or both opposing, flat major surfaces of the glass sheet. As used herein, an air knife shall mean an apparatus used to exhaust a volume of gas, typically, although not necessarily, as an elongated curtain of gas, under pressure (e.g., at a predetermined velocity). While the term “air” is used generically in referring to the apparatus, the apparatus is not restricted to the use of air as the exhausted gas, and may use other gases or mixture of gases, depending on need.

The outlet of the air knife (e.g., an elongated slot, series of orifices, etc.) can be obliquely arranged relative to the path of travel of the glass sheet. The resultant curtain of gas delivered by the air knife will readily direct liquid to, and then off, an edge of the glass sheet. Conventional air knives are currently employed with glass sheet finishing lines, and can include an elongated housing forming a chamber leading to the air knife outlet. Forced gas flow is provided from a supply (e.g., blower or pump) to the chamber via an inlet port located at an end of the elongated housing. However, the drying performance of current air knife designs may not adequately meet the ever-increasing demands of glass sheet mass production, particularly in view of the increasing dimensions of commercially available glass sheets.

As a point of reference, the time window for the glass sheet drying process (e.g., as part of a glass sheet finishing line) is generally less than one minute. Flat surface drying time depends on volume and flow rate of the gas exhausted from the air knife, as well as the uniformity of the gas flow distribution along the air knife outlet. With this in mind, as the size of glass sheets and line speeds are increased (e.g., in an effort to reduce manufacturing costs), the length of the air knife may also be increased to cover the entire glass sheet surface area and to dry the surfaces within a very short time frame. Further, to accommodate elevated transport speeds, a higher gas volume from the air knife is required to dry the glass sheet surface within the same time. While it may be possible to simply increase the gas flow rate from the gas supply source, in many instances the existing gas supply source limits the gas volume that can be delivered. However, the gas supply source may be unable to generate the delivery system pressure necessary to achieve the desired air knife outlet flow rate. Even if the gas supply source can deliver high pressure, the gas volume delivered will still be limited, with the flow choked once the ratio of ambient atmospheric pressure and gas supply pressure reach 0.528. Moreover, increasing the gas flow rate from the supply will increase the velocity of gas exiting the air knife. This elevated velocity gas, in turn, can lead to undesirable instabilities in the glass sheet as it is being conveyed past the air knife. Finally, as the length of the conventional air knife outlet is increased, gas flow distribution along the outlet becomes less uniform and thus less able to achieve consistent drying performance across the glass sheet surface.

Thus, alternative air knife constructions that can deliver a higher gas flow rate in drying a substrate surface, such as a surface of a glass sheet conveyed through a finishing line, without a significant increase in pressure at the gas supply source (e.g., blower or pump) are needed.

Accordingly, methods of drying a moving sheet of material are disclosed comprising conveying the sheet of material adjacent an air knife in a conveyance direction, supplying the air knife with a drying gas, the drying gas exiting an exhaust slot of the air knife in a direction toward the sheet of material, and wherein a pressure drop between an inlet to the air knife and the exhaust slot of the air knife is less than 90.6 kPa and a velocity of the drying gas exiting the air knife over the length of the exhaust slot does not vary over the length of the exhaust slot by more than 1% from an average velocity of the gas exiting the slot.

In embodiments, the velocity of the drying gas exiting the air knife over the length of the exhaust slot does not vary over the length of the exhaust slot by more than 0.4% from the average velocity of the gas exiting the exhaust slot. In certain embodiments, an angle α between a longitudinal axis (or plane) of the air knife and the conveyance direction is in a range from about 65° to about 75°.

The air knife can comprise a tip portion including an exit face comprising the exhaust slot, the tip portion comprising converging exterior side surfaces intersecting the exit face, and an angle between the converging side surfaces is less than 90 degrees. In some embodiments, a width of the exit face in a direction orthogonal to the longitudinal axis of the air knife can be less than 10 times a width of the exhaust slot. In some embodiments, a distance between the exit face and the surface of the sheet of material can be in a range from about 1 mm to about 10 mm. In certain embodiments, a length of the exhaust slot can be equal to or greater than 3.5 meters. A conveyance speed of the glass sheet can be at least 8 m/min.

In other embodiments, an air knife is described, the air knife comprising, a main body comprising an inlet portion comprising a plenum, an outlet portion comprising an exit orifice in fluid communication with the plenum, and a plurality of inlet ports projecting from the inlet portion, each inlet port of the plurality of inlet ports comprising a passageway in fluid communication with the plenum.

In some embodiments, the inlet portion comprises a trailing wall, and each inlet port of the plurality of inlet ports projects from the trailing wall.

In embodiments, the plenum can comprise an upstream side opposite a downstream side, and the trailing wall borders the upstream side. The plurality of inlet ports may project, for example, from a planar surface of the trailing wall.

In some embodiments, the trailing wall can define a length equal to a length of the exit orifice, and further wherein the plurality of inlet ports can be aligned with and spaced apart from one another along the length of the trailing wall.

In various embodiments, the outlet portion can comprise a channel region comprising a channel in fluid communication with and extending downstream from the plenum and a tip region extending from the channel region to an exit face, the exit orifice defined in the exit face, and wherein an exterior surface of the tip region comprises first and second side faces intersecting opposing edges of the exit face, respectively, the first and second side faces defining a taper angle therebetween less than 90 degrees.

The exit orifice can be an elongated slot, and a length of each of the first and second side faces can be greater than the length of the elongated slot.

In some embodiments, the outlet portion can comprise a channel region comprising a channel extending downstream from and in fluid communication with the plenum and the exit orifice, and a minor dimension of the channel is less than a minor dimension of the plenum. The minor dimension of the channel can be a diameter of the channel and the minor dimension of the plenum can be a depth of the plenum.

In some embodiments, the exit orifice can be an elongated slot comprising a width and a length greater than the width, and the minor dimension of the channel is greater the width of the elongated slot. A centerline of the channel can be perpendicular to a plane of the exit face, and a centerline of the plenum can be perpendicular to the centerline of the channel.

In certain embodiments, the outlet portion can further define a secondary chamber in fluid communication with the plenum and the channel, a minor dimension of the secondary chamber can be less than the minor dimension of the plenum, and the minor dimension of the secondary chamber can be greater than the minor dimension of the channel.

In yet another embodiment. an apparatus for drying a sheet of material is disclosed, the apparatus comprising a conveyance device establishing a path of travel for the sheet of material, a supply of gas, and an air knife comprising: a main body comprising an inlet portion defining a plenum, an outlet portion defining an exit orifice in fluid communication with the plenum, and a plurality of inlet ports each input port projecting from the inlet portion and defining a passageway in fluid communication with the plenum, wherein the plurality of inlet ports are in fluid communication with the supply of gas, and further wherein the exit orifice is arranged adjacent the path of travel to discharge a stream of gas received from the supply of gas onto a surface of the glass sheet being conveyed by the conveyance device.

In some embodiments, the inlet portion comprises a trailing wall defining an upstream side of the plenum, the upstream side opposite a downstream side, and further wherein each of the plurality of inlet ports projects from the trailing wall.

In some embodiments, the outlet portion can comprise a channel region defining a channel in fluid communication with and extending downstream from the plenum and a tip region extending from the channel region to an exit face, the exit orifice being defined in the exit face. An exterior surface of the tip region can comprise first and second side faces intersecting opposing edges of the exit face, respectively, and the first and second side faces define a taper angle less than 90 degrees.

In some embodiments, the outlet portion can comprise a secondary chamber in fluid communication with the plenum, wherein a minor dimension of the secondary chamber can be less than a minor dimension of the plenum, and a channel in fluid communication with the chamber and the exit orifice, the channel extending downstream from the secondary chamber, wherein a minor dimension of the channel is less than the minor dimension of the plenum.

In still other embodiments, a system for processing a sheet of material is disclosed, the system comprising a conveyance device establishing a path of travel for the sheet of material, a cleaning apparatus comprising a spray device arranged to distribute a cleaning solution onto a surface of the sheet of material conveyed by the conveyance device, and a drying apparatus comprising: a supply of gas, and an air knife arranged downstream of the spray device, the air knife comprising: a main body comprising: an inlet portion defining a plenum, an outlet portion defining an exit orifice in fluid communication with the plenum, and a plurality of inlet ports projecting from the inlet portion, each inlet port defining a passageway in fluid communication with the plenum, wherein the plurality of inlet ports are in fluid communication with the supply of gas, and further wherein the exit orifice is arranged adjacent the path of travel to discharge a stream of gas received from the supply of gas onto the surface of the glass sheet being conveyed by the conveyance device.

The inlet portion comprises a trailing wall defining an upstream side of the plenum, the upstream side being opposite a downstream side, and further wherein each of the at least three inlet ports projects from the trailing wall.

The outlet portion can comprise a channel region defining a channel in fluid communication with and extending downstream from the plenum, and a tip region extending from the channel region to an exit face, the exit orifice being defined in the exit face, wherein an exterior surface of the tip region comprises first and second side faces intersecting opposing edges of the exit face, respectively, and further wherein the first and second side faces a taper angle less than 90 degrees.

In some embodiments, the outlet portion can comprise a secondary chamber in fluid communication with the plenum, wherein a minor dimension of the secondary chamber is less than a minor dimension of the plenum, and a channel in fluid communication with the chamber and the exit orifice, the channel extending downstream from the chamber, wherein a minor dimension of the channel is less than the minor dimension of the plenum.

Additional features and advantages will be set forth in the detailed description which follows, and in part will be apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

### BRIEF DESCRIPTION OF THE DRAWINGS

FIG. 1A is a simplified top view of a portion of a drying apparatus in accordance with principles of the present disclosure;

FIG. 1B is a simplified side view of the drying apparatus of FIG. 1A;

FIG. 2 is a simplified side view of an air knife in accordance with principles of the present disclosure and useful with the drying apparatus of FIG. 1A;

FIG. 3 is a simplified end view of the air knife of FIG. 2;

FIG. 4 is a cross-sectional view of the air knife of FIG. 2;

FIG. 5 is an enlarged cross-sectional view of a portion of the air knife of FIG. 2;

FIG. 6 schematically illustrates a glass sheet processing system in accordance with principle of the present disclosure; and

FIG. 7 is a plot of test result of the Examples section.

### DETAILED DESCRIPTION

Reference will now be made in detail to various embodiments of air knives, drying apparatus, systems and methods for processing a substrate sheet, such a surface of a glass sheet. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as may be used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

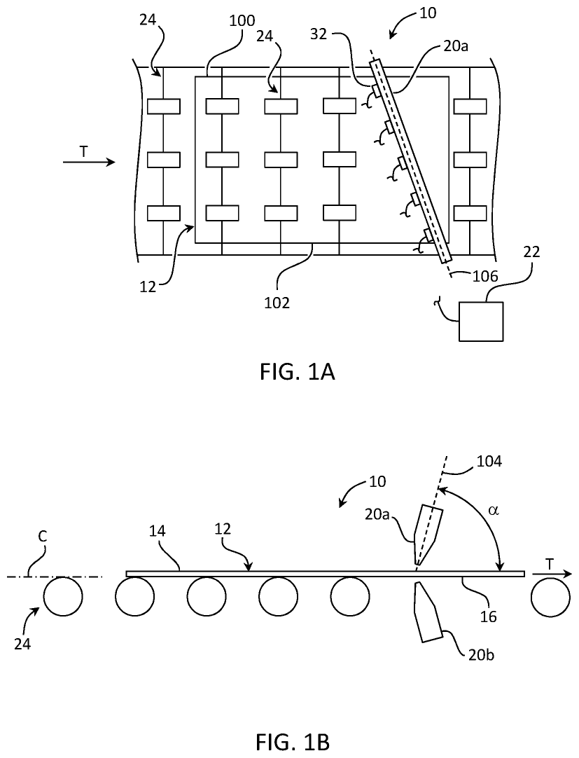

FIGS. 1A and 1B illustrate an exemplary drying apparatus 10 in accordance with principles of the present disclosure for processing (e.g., drying) a surface or surfaces of a sheet of material, e.g., glass sheet 12. As a point of reference, and as identified in FIG. 1B, glass sheet 12 defines opposing, first and second major surfaces 14 and 16, respectively, and drying apparatus 10 can be configured to dry one or both of the first and second major surfaces 14, 16. Although drying apparatus 10 is described herein as being used to dry a glass sheet, it should be understood that drying apparatus 10 (as well as other apparatus and systems of the present disclosure) can also be used to process other types of materials such as polymers (e.g., Plexi-Glass™), metals, or other substrate sheets. Accordingly, drying apparatus 10 should not be construed in a limited manner.

Drying apparatus 10 can include one or more air knives in accordance with principles of the present disclosure, such as first and second air knives 20a, 20b, respectively, along with gas supply source 22 and conveyance device 24. The first and second air knives 20a, 20b are described in greater detail below. In general terms, conveyance device 24 transports glass sheet 12 in conveyance direction T. First and second air knives 20a, 20b are arranged to direct a flow (e.g., curtain) of exhausted gas onto one or both of first and/or second major surfaces 14, 16, respectively, as glass sheet 12 is transported past first and/or second air knives 20a, 20b by conveyance device 24, serving to remove contaminating matter (e.g., liquid, particles, etc.) from the corresponding first and/or second major surface(s) 14, 16.

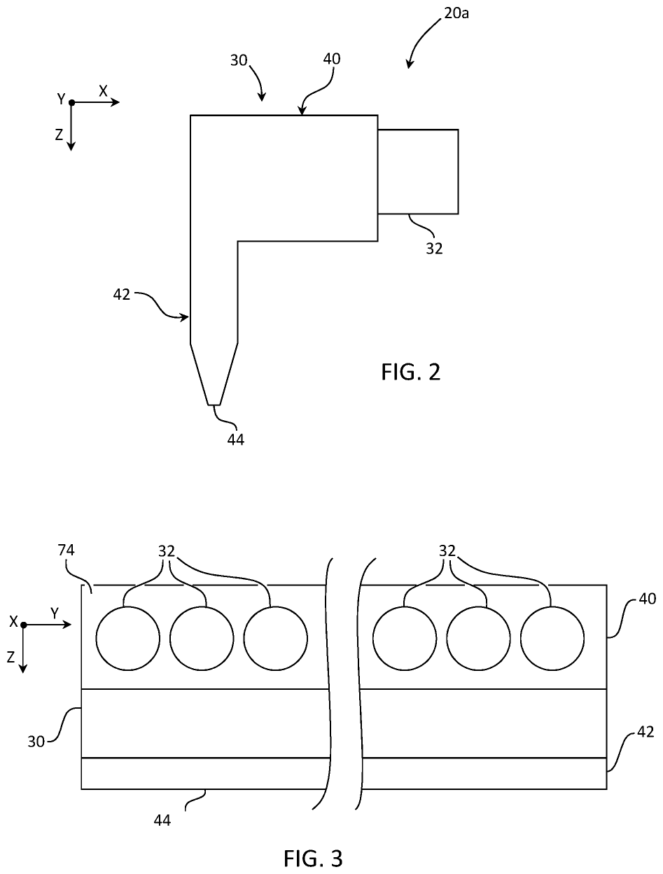

For drying apparatus of the present disclosure having two or more air knives (e.g., drying apparatus 10 depicted in FIGS. 1A and 1B), the air knives can be identical. Thus, the following descriptions of first air knife 20a can apply equally to second air knife 20b. Accordingly, and with reference to FIGS. 2-4, first air knife 20a comprises main body 30 and one or more inlet ports 32. For example, first air knife 20a may comprise two inlet ports, three inlet ports, four inlet ports, five inlet ports, six inlet ports, and so forth. Main body 30 can assume a variety of exterior shapes, and can be viewed as forming or providing an inlet portion 40 and an outlet portion 42. The one or more inlet ports 32 extend from inlet portion 40 as described below, and are in fluid communication with an interior passage of main body 30. Outlet portion 42 extends from inlet portion 40 and terminates at exit face 44. Interior passages defined along inlet and outlet portions 40, 42, respectively, collectively serve to discharge pressurized gas, received at the one or more inlet ports 32, from an exit orifice defined by exit face 44. For reasons made clear below, main body 30 comprises an elongated shape, whereby (and with reference to the X, Y, Z coordinate system identified in the views) a length (dimension in the Y direction) of main body 30 is greater than a width (dimension in the X direction) of main body 30, for example at least 10 times greater.

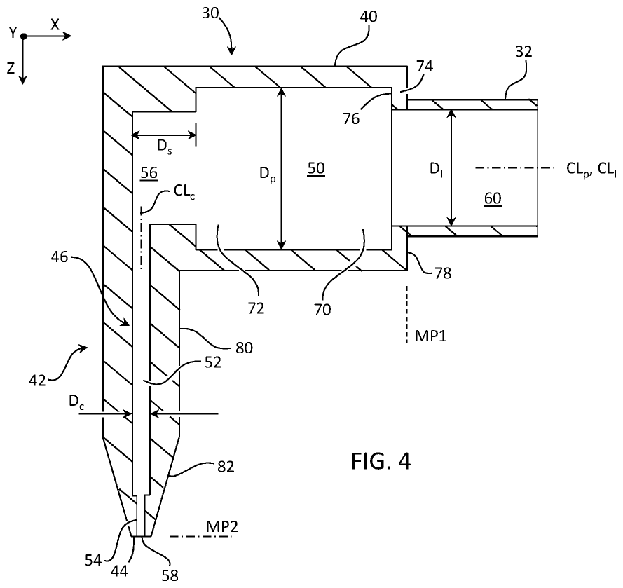

Interior passages of main body 30 are shown in FIG. 4, and include a plenum 50 defined within inlet portion 40, and a channel 46 positioned within outlet portion 42. For example, channel 46 can comprise first channel portion 52 and second channel portion 54. Main body 30 may optionally include a secondary chamber 56. Exit orifice 58 is defined in exit face 44 and is open to (in fluid communication with) second channel portion 54. Exit orifice 58 can assume various forms, and, in some embodiments, can be an elongated slot (e.g., relative to the X, Y, Z coordinate system identified in FIGS. 2-4), wherein a length (dimension in the Y direction) of the exit orifice 58 is greater than a width of the exit orifice (dimension in the X direction—e.g., slot width), for example at least 10 times greater. For example, a length of exit orifice 58 can be equal to or greater than 2 meters, for example equal to or greater than 2.5 meters, equal to or greater than 3 meters, such as equal to or greater than 3.5 meters. In other embodiments, exit orifice 58 can include a plurality of orifices, apertures, slots, etc. Regardless, plenum 50, first channel portion 52, and second channel portion 54 are in fluid communication with one another such that gas supplied to plenum 50 via the one or more inlet ports 32 (one of which is shown in FIG. 4) flows to second channel portion 54 through plenum 50 and first channel portion 52, and is discharged through exit orifice 58. The number of inlet ports 32 is dependent on, for example, the lengths of plenum 50 and exit orifice 58 in the Y direction.

One or more geometric features of first air knife 20a facilitate a transition of low-pressure gas received at plenum 50 from the one or more inlet ports 32 to a gas flow discharged from exit orifice 58 that exhibits a large, substantially uniform flow velocity over the entire length—Y direction—of the exit orifice 58 (e.g., within 1% of the average flow velocity over the entire length of the exit orifice 58). For example, a shape of plenum 50 can be viewed as having a length (Y direction), width (X direction), and depth (Z direction). Commensurate with the elongated shape of main body 30 as mentioned above, the length of plenum 50 is greater than the width and depth of the plenum. The smallest dimension of plenum 50 in the length, width, or depth direction can be designated as a minor dimension D_{P} of plenum 50, and is identified in FIG. 4. As mentioned above, the one or more inlet ports 32 are arranged to deliver supplied gas to plenum 50 via a passageway 60. A size (e.g., diameter D_{I}) of each of the inlet port passageways 60 approaches the minor dimension D_{P} of plenum 50, and is thus large compared to conventional air knife constructions. In some embodiments, for example, inlet port passageway diameter D_{I} is equal to or greater than about 50% of the plenum minor dimension D_{P}, for example equal to or greater than about 60%, equal to or greater than about 70%, and in some embodiments equal to or greater than 80% of the plenum minor dimension D_{P}. In other embodiments, inlet port passageway diameter D_{I} is equal to or greater than about 15 mm, alternatively equal to or greater than about 18 mm, alternatively equal to or greater than about 20 mm, and in some embodiments equal to or greater than about 23 mm. The larger inlet ports 32 (relative to the minor dimension D_{P} of plenum 50) promotes uniformity of gas flow delivered to plenum 50.

Additionally, the one or more inlet ports 32 are optionally located at a rear of main body 30, as shown in FIGS. 2 and 3. By way of further explanation, plenum 50 can be defined in part by an upstream side 70 opposite a downstream side 72 relative to gas flow through main body 30. The upstream side 70 is in direct fluid communication with the inlet port passageways 60, whereas the downstream side 72 is in fluid communication with the first channel portion 52 (either directly or via optional secondary chamber 56). Upstream side 70 is defined by a trailing wall 74 of inlet portion 40 of main body 30. In particular, and as identified in FIG. 4, trailing wall 74 defines an interior surface 76 opposite an exterior surface 78. Interior surface 76 generates upstream side 70 of plenum 50, whereas the one or more inlet ports 32 project from exterior surface 78. Stated otherwise, trailing wall 74 (from which the one or more inlet ports 32 project) is positioned opposite exit orifice 58 (e.g., relative to the gas flow path provided by main body 30, interior surface 76 of trailing wall 74 is the internal surface of main body 30 farthest from exit orifice 58). In some embodiments, at least the region of exterior surface 78 from which the one or more inlet ports 32 project can be substantially planar surface. Alternatively, an arrangement of the one or more inlet ports 32 at a “rear” of main body 30, e.g., trailing wall 74, can be described with reference to a centerline CL_{P} generated by a shape of plenum 50 along the flow path (i.e., from upstream side 70 to downstream side 72). For example, in some embodiments a centerline CL_{I} defined by inlet port passageway 60 of each of the inlet ports 32 may be parallel with the centerline CL_{P} of plenum 50. A major plane MP1 defined by exterior surface 78 of trailing wall 74 (i.e., the surface of main body 30 from which the one or more inlet ports 32 project) can be orthogonal to centerline CL_{P} of plenum 50. However, it should be noted that in further embodiments, centerline CL_{I} may be non-parallel with centerline CL_{P} of plenum 50.

With the above conventions in mind, and with reference to FIG. 3, in some embodiments, the one or more inlet ports 32 project from trailing wall 74 and can be aligned with one another in the length direction (Y direction). In this regard, a shape of the trailing wall 74 can correspond with the optional elongated shape of main body 30, comprising a length dimension (Y direction) greater than a depth dimension (Z direction) and the width dimension (X direction) (it being understood that the width dimension (X direction) corresponds with a thickness of trailing wall 74 relative to the orientation of the views of FIGS. 2-4). The length of trailing wall 74 can be equal to the length (Y direction) of exit orifice 58 (hidden in FIG. 3, but generally corresponding with exit face 44). The one or more inlet ports 32 are aligned with one another along the length of trailing wall 74, and, in some embodiments, can be equidistantly spaced from one another.

With the above constructions, by locating the one or more inlet ports 32 at the rear of main body 30, substantially uniform gas flow is delivered to plenum 50 (FIG. 4) (e.g., the gas flow collectively delivered to plenum 50 via the one or more inlet ports 32 is substantially uniform relative to at least the length dimension (Y direction) of plenum 50). This substantially uniform gas flow at plenum 50 is maintained throughout the flow path of main body 30, such that gas flow discharged from exit orifice 58 (hidden in FIG. 3) is also substantially uniform (along or relative to the length (Y direction) of exit orifice 58). In other embodiments, one or more of the inlet ports 32 can be located or projected from other surfaces of main body 30.

Returning to FIG. 4, plenum 50 is in fluid communication with first channel portion 52, for example via the optional secondary chamber 56. Where provided, a shape of secondary chamber 56 can assume various forms, and is defined by a length dimension (Y direction), width dimension (X direction) and depth dimension (Z direction). Commensurate with the elongated shape of main body 30 mentioned above, the length of secondary chamber 56 is greater than the width and depth of secondary chamber 56. The smallest dimension of the secondary chamber 56 in the length, width, or depth direction can be designated as a minor dimension D_{S} of the secondary chamber 56, and is identified in FIG. 4 (e.g., commensurate with the width or X direction dimension of the secondary chamber 56). A volume of secondary chamber 56 can be less than the volume of plenum 50. For example, a transition from plenum 50 to secondary chamber 56 can be characterized by a reduction or taper in the depth dimension (Z direction).

A shape of first channel portion 52 can also assume various forms, and is defined by a length dimension (Y direction), width dimension (X direction) and depth dimension (Z direction). Commensurate with the elongated shape of main body 30 as mentioned above, the length of first channel 52 can be greater than the width and depth of the channel. The smallest dimension of first channel portion 52 in the length, width, or depth direction can be designated as a minor dimension D_{C} of first channel portion 52, and is identified in FIG. 4 (e.g., commensurate with the width or X direction dimension of the first channel portion 52). The minor dimension D_{C} of first channel portion 52 can be less than the minor dimension D_{P} of plenum 50, such that the velocity of gas flow is increased along first channel portion 52 (compared to gas flow velocity in plenum 50). However, a volume of first channel portion 52 can be large compared to conventional air knife constructions to minimize resistance to gas flow at plenum 50 via the one or more inlet ports 32 at relatively low supply pressures. For example, in some non-limiting embodiments, minor dimension D_{C} of first channel portion 52 can be equal to or greater than about 15% of the inlet port diameter D_{I}. Alternatively, or in addition, the minor dimension D_{C} of first channel portion 52 can be equal to or greater than about 10% of the minor dimension D_{P} of plenum 50 in some embodiments. In yet other embodiments, the minor dimension D_{C} of first channel portion 52 (e.g., width or X direction dimension) can be equal to or greater than about 2 mm, alternatively equal to or greater than about 3 mm, and in some embodiments equal to or greater than about 4 mm. Other dimensions are also envisioned. For example, the minor dimension D_{C} of first channel portion 52 can be equal to or greater than about 16 mm.

Where provided, geometries of secondary chamber 56 relative to one or both of plenum 50 and first channel portion 52 may also be beneficial. Secondary chamber 56 serves as a transition from plenum 50 to first channel portion 52. In some embodiments, minor dimension D_{S} of secondary chamber 56 is less than minor dimension D_{P} of plenum 50, and is greater than the minor dimension D_{C} of first channel portion 52. With this construction, a more gradual transition and lessened resistance to gas flow from plenum 50 to first channel portion 52 can be provided. In other embodiments, minor dimension D_{S} of secondary chamber 56 (e.g., width or X direction dimension) is equal to or greater than about 10 mm, alternatively equal to or greater than about 11 mm, and in some embodiments equal to or greater than about 12 mm, although in further embodiments other dimensions are also envisioned.

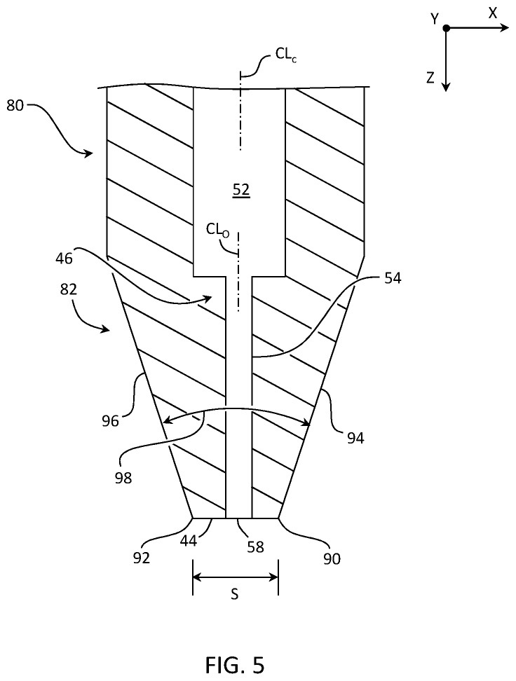

Second channel portion 54 represents a further flow path size reduction, causing an increase in flow velocity from first channel portion 52 to and from exit orifice 58. Second channel portion 54 and optional features associated with exit face 44 are shown in FIG. 5 and described in greater detail below. In general terms, the minor dimension of second channel portion 54 is less than the minor dimension D_{C} of first channel portion 52.

In some embodiments, main body 30 can be configured to cause a turn in gas flow when flowing from plenum 50 to exit orifice 58. For example, main body 30 can be sized and shaped such that, relative to a flow direction from the one or more inlet ports 32 to exit orifice 58, a shape of first channel portion 52 establishes a centerline CL_{C} that is parallel with a centerline CL_{O} (FIG. 5) of exit orifice 58. In some embodiments, CL_{C} and CL_{O} can be coincident. As described below, the centerline CL_{C} of first channel portion 52 can be orthogonal to a major plane MP2 of exit face 44. In some embodiments, the centerline CL_{C} of first channel portion 52 and/or the centerline CL_{O} of exit orifice 58 can be orthogonal to the centerline CL_{P} of plenum 50 and/or the centerline C_{I} of the one or more inlet ports 32. Other geometries are also acceptable.

Outlet portion 42 can be shaped to define a channel region 80 and a tip region 82. First channel portion 52 can be formed within channel region 80. Tip region 82 extends from channel region 80 to exit face 44 and can define at least a portion of second channel portion 54. With these designations in mind, FIG. 5 illustrates optional features of tip region 82 in greater detail. As shown, tip region 82 tapers in the depth direction (Z direction) from channel region 80 to exit face 44. For example, exit face 44 can be substantially planar (i.e., within 10 degrees of a truly planar surface), terminating at opposing, first and second edges 90, 92. An exterior of tip region 82 intersects first and second edges 90, 92, and includes opposing, first and second side faces 94, 96. First side face 94 intersects first edge 90, and second side face 96 intersects second edge 92. A taper of tip region 82 can be described with reference to a taper angle 98 defined by opposing first and second side faces 94, 96 (i.e., the taper angle 98 is an included angle formed by the planes of first and second side faces 94, 96). In some embodiments, taper angle 98 is equal to or less than about 90 degrees, alternatively equal to or less than about 85 degrees, alternatively equal to or less than about 80 degrees, and in some embodiments equal to or less than about 75 degrees, for reasons made clear below.

Exit orifice 58 can be formed in exit face 44. In some embodiments, a linear distance S (minor dimension) of exit face 44 in the width or X direction between first and second edges 90, 92 is small. For example, S can be equal to or less than about 3 mm, alternatively equal to or less than about 2.5 mm, alternatively equal to or less than about 2.4 mm, and in some embodiments equal to or less than about 2.3 mm for reasons made clear below. Other dimensions are also envisioned. In various embodiments, exit orifice 58 can have a minor dimension (e.g., width or X direction dimension) equal to or less than about 150 μm.

It has been found that by optionally forming tip region 82 to have taper angle 98 and/or exit face 44 to have minor dimension S described above, the opportunity for glass sheet stability disturbances at expected flow rates and standoff distances is minimized. As a point of reference, with conventional air knife constructions useful for drying glass sheets as part of a glass sheet finishing line, negative pressure can be generated between the flat surface of the exit nosing and the glass sheet surface. If the magnitude or the area of this negative pressure is too large, a net suction force is applied on the glass sheet surface that in turn can lead to glass sheet instability, damage, etc. This suction force will increase if flow rate increases or the standoff distance is decreased. By forming taper angle 98 to be equal to or less than about 90 degrees as described above, the likelihood of a suction force being generated on the glass sheet surface at short standoff distances (e.g., 2.5 mm or less) or high flow rates is minimized. Similarly, by forming exit face 44 minor dimension S as described above, the magnitude of the suction force, if any, is minimized.

Returning to FIGS. 1A and 1B, gas supply source 22 is in fluid communication with one or both of first and second air knives 20a, 20b. For example, FIG. 1A illustrates gas supply source 22 in fluid communication with each of the inlet ports 32 of first air knife 20a. The same gas supply source 22 can also be in fluid communication with the inlet ports 32 of the second air knife 20b (FIG. 1B). In other embodiments, two or more gas supply sources 22 can be provided, each gas supply source 22 in fluid communication with one or more of the inlet ports 32 of one or more of the air knives provided with the drying apparatus. Regardless, the gas supply source(s) 22 incorporates one or more mechanisms or devices appropriate for generating forced gas flow (e.g., blower, fan, pump, etc.), along with a supply of the gas and various control devices (e.g., valves) as desired. The gas may be, for example, air, although any suitable gas may be employed, including without limitation inert gases such as nitrogen, argon, krypton, helium, neon and combinations thereof. Nitrogen is a cost-effective alternative to air if air cannot be used for any reason.

Conveyance device 24 can assume various forms as known in the art appropriate for transporting substrate sheets, such as glass sheet 12. For example, conveyance device 24 can include one or more driven rollers, endless bands or belts, air bearings, etc., along with corresponding drive and control devices. Regardless of an exact construction, conveyance device 24 establishes a conveyance plane C along which the glass sheet is conveyed. The conveyance device 24 can be configured to provide glass sheet travel or conveyance speeds as desired. In some embodiments, for example, the conveyance device 24 can be configured to convey the glass sheet 12 at a velocity of at least about 8 meters per minute (m/min), optionally at least about 12.6 m/min, and in some embodiments at least about 15 m/min.

Final arrangement of first and second air knives 20a, 20b relative to conveyance device 24 includes exit orifice 58 of first air knife 20a positioned adjacent to and above conveyance plane C, and exit orifice 58 of second air knife 20b positioned adjacent to and below conveyance plane C. A distance between the respective exit orifice 58 and an adjacent major surface of glass sheet 12 (and thus the standoff distance between exit orifice 58 and the adjacent major surface of glass sheet 12) can vary, and, in some embodiments, can be equal to or less than about 2.5 mm.

Drying apparatus 10 can be configured to handle or process a wide variety of differently-sized glass sheets 12. In this regard, the glass sheet 12 defines opposing, first and second side edges 100, 102 (it being understood that first and second side edges 100, 102 extend between the opposing, first and second major surfaces 14, 16), with a width of glass sheet 12 comprising a linear distance between opposing first and second side edges 100, 102. In some instances (such as with the arrangement of FIG. 1A), glass sheet 12 is arranged along conveyance device 24 such that the width of glass sheet 12 is orthogonal to direction of travel T. Regardless, drying apparatus 10 is configured to process large width glass sheets, such as glass sheets with a width of at least about 2 m, optionally at least about 2.5 m. A length of the air knife (or air knives), and in particular exit orifice 58 of the air knife, employed with the drying system is selected to accommodate (e.g., approximate or exceed) the expected width of the glass sheet 12 to be processed by drying apparatus 10, upon final arrangement relative to conveyance device 24. In this regard, and as reflected by FIG. 1B, in some embodiments, one or more of the air knives, such as first air knife 20a, can be arranged such that an axis 104 of the air knife (e.g., along centerline CL_{c}) is at an angle α in a range from about 65° to 75° relative to a major surface of the glass sheet adjacent the air knife the direction of travel T (with this angle sometimes being referred to as the air knife tilt angle). Additionally, an axis 106 of the air knife extending generally in the Y or length direction of the air knife, as indicated in FIG. 2, can be arranged at an oblique angle β (slant angle) relative to direction of travel T, as shown in FIG. 1A. Slant angle β can be in a range from about 45° to about 80° relative to travel direction T, such as in a range from about 60° to about 75°, although other slant angles are contemplated. The second air knife 20b can be similarly arranged on the opposite side of the glass sheet. With this configuration, as glass sheet 12 is conveyed relative to first air knife 20a, the gas stream discharged from first air knife 20a onto first major surface 14 of glass sheet 12 will sweep or urge liquid droplets or other matter residing on first major surface 14 toward second side edge 102 (or first side edge 100 depending on the direction of the oblique angle). Other arrangements of first and second air knives 20a, 20b relative to direction of travel T are also acceptable. A size of first and second air knives 20a, 20b, and in particular a length of exit orifices 58, is selected such that upon final arrangement relative to the conveyance device 24, the exit orifices 58 will encompass an entirety of the expected width of the glass sheet 12 to be processed.

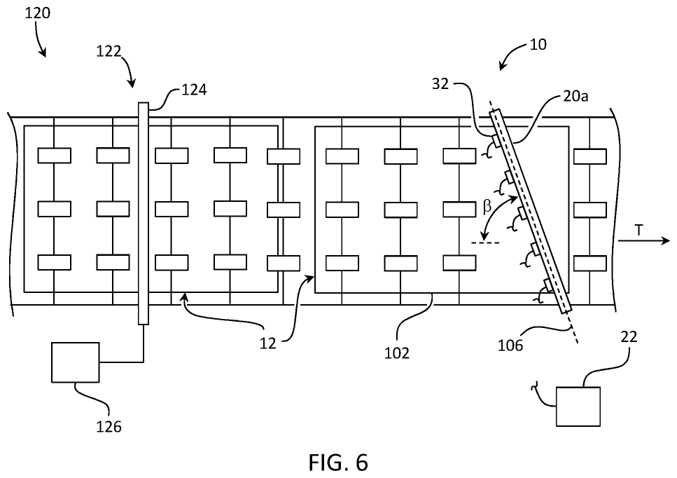

In some embodiments, the air knives and drying apparatus of the present disclosure can be provided as part of an in-line glass sheet processing system, such as processing system 120 of FIG. 6. Processing system 120 includes drying apparatus 10 as described above (and including one or more of the air knives of the present disclosure, such as first air knife 20a), along with a cleaning apparatus 122. Cleaning apparatus 122 can assume various forms as known in the art appropriate for performing a cleaning or washing operation, and can include, for example, one or more spray devices 124 and a cleaning solution supply source 126. The cleaning apparatus 122 and the drying apparatus 10 are arranged in-line, including the spray device(s) 124 positioned to applying a cleaning solution (e.g., water, detergent, etc.) onto glass sheets conveyed by conveyance device 24 in travel direction T, and first air knife 20a located downstream of spray device 124. The processing system 120 can include additional components or stations upstream of cleaning apparatus 122 and/or downstream of drying apparatus 10 (e.g., a cutting, grinding or polishing station upstream of the cleaning apparatus 122; an inspection or packaging station downstream of the drying apparatus 10, etc.). Regardless, processing system 120 operates to convey glass sheets 12 in travel direction T, with cleaning apparatus 122 operating to wash or clean one or both major surfaces of glass sheets 12 followed by drying apparatus 10 operating to dry the so-washed major surface(s) as described above.

### EXAMPLES

Some objects and advantages of the present disclosure are further illustrated by the following non-limiting examples and comparative examples. The particular dimensions, conditions and details should not be construed to unduly limit the present disclosure.

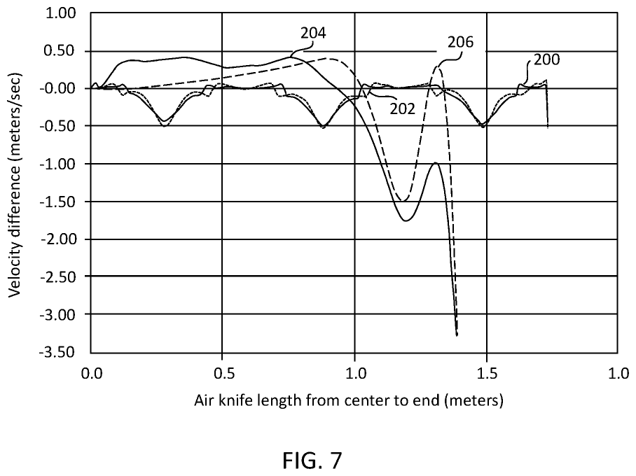

To evaluate flow uniformity, the variation in flow velocity of gas flow exiting an air knife in accordance with principles of the present disclosure was determined. In particular, a first example air knife with a construction similar to FIGS. 2-4 was considered, including an exit orifice (elongated slot) length of approximately 3.2 meters (m). The flat exit face of the first example air knife comprised a width (i.e., the minor dimension S in FIG. 5) of 2.3 millimeters (mm). The inlet port passageway diameter (D_{I}) was 33 mm. The minor dimension (D_{S}) of the secondary channel was 16 mm. The minor dimension (D_{C}) of the channel was 16 mm. At two supply gas volume rates (7 liters per minute (1/min) and 10 1/min), the change in velocity of gas flow exiting the first example air knife was determined at various locations between a center of the exit orifice length and an end of the exit orifice length. For purposes of comparison, similar evaluations were performed on an existing air knife used in the drying of glass sheets. The existing air knife included two inlet ports, one at each end of the elongated air knife main body (e.g., such that the supplied gas was delivered substantially parallel with a length direction of the air knife). The length of the exit orifice (elongated slot) of the existing air knife was approximately 2.8 mm. The results of the flow uniformity evaluations are reported in FIG. 7, in particular the gas flow velocity variation relative to the velocity at the center of the air knife exit orifice are recorded. Plot line 200 represents velocity differences determined for the first example air knife at a supply flow rate of 7 liters/min, plot line 202 represents velocity differences determined for the first example air knife at a supply flow rate of 10 liters/min, plot line 204 represents velocity differences determined for the existing air knife at a supply flow rate of 7 liters/min, and plot line 206 represents velocity differences determined for the existing air knife at a supply flow rate of 10 liters/min. The flow uniformity evaluations revealed that with the first example air knife, uniformity was within 0.5 meters per second (m/s), or 0.4%, for both high and low supply flow rates. In comparison, the existing air knife exhibited a variation of about 3.5 m/s or 1.8%. Further, the variation in flow uniformity of the first example air knife was consistently low across the entire length. In contrast, significant variation occurred at the end of the existing air knife, which may lead to insufficient drying of the glass sheet surface close to the side edge.

A second example air knife in accordance with principles of the present disclosure was constructed in accord with FIGS. 2-5. The second example air knife formed the exit orifice as an elongated slot. The flat exit face of the second example air knife comprised a width (i.e., minor dimension S in FIG. 5) of 2.3 mm. The inlet port diameter (D_{I}) was 23 mm. The minor dimension (D_{S}) of the secondary channel was 12 mm. The minor dimension (D_{C}) of the channel was 4 mm.

Tests were performed to determine the required inlet pressure necessary to deliver the same flow rate per unit length for the first and second example air knives (at a total flow rate of 8.7 m³/min). A required inlet pressure for the first example air knife was determined to be 27,195 Pascal (Pa) for the first example air knife, and 26,461 Pa for the second example air knife. Thus, some embodiments of the air knives of the present disclosure do not compromise air volume delivery capability while maintaining excellent flow velocity.

Two of the second example air knives described above were installed on the drying apparatus of an existing glass sheet processing system that further included a washing station (e.g., the arrangement of FIG. 6). In particular, one of the second example air knives (designated as “Top AK”) was installed above the conveyance device at a standoff distance of 3.5 mm. The other example air knife (designated as “Bottom AK”) was installed below the conveyance device at a standoff distance of 3 mm. The top and bottom air knives were both arranged at a tilt angle of 67 degrees relative to direction of travel T. Glass sheets were then processed by the processing system by conveying the glass sheets through the washing station. A cleaning solution was applied to the major surfaces of the glass sheet, followed by drying. In particular, tests were run using different supply system pressures and volumes and at different conveyance speeds (Mpa/m³ in the Table). Following each cycle, the major surfaces of the test glass sheets were visually reviewed for the presence of liquid. The test parameters and results are reported in the Table below.

TABLE

| | Top AK | Bottom AK | | | |
|---|---|---|---|---|---|
| | pressure/ | pressure/ | Conveyance | | Liquid |
| | volume | volume | Speed | | Evaluation |
| Test 1 | 0.04 Mpa/ | 0.035 Mpa/ | 8 | m/min | Dry |
| | 7.3 m³ | 6.35 m³ | | | |
| Test 2 | 0.04 Mpa/ | 0.035 Mpa/ | 12.6 | m/min | Moist spot |
| | 7.3 m³ | 6.35 m³ | | | remained for |
| | | | | | ~5 seconds |
| Test 3 | 0.06 Mpa/ | 0.055 Mpa/ | 8 | m/min | Dry |
| | 8.9 m³ | 8.75 m³ | | | |
| Test 4 | 0.06 Mpa/ | 0.055 Mpa/ | 12.6 | m/min | Dry |
| | 8.9 m³ | 8.75 m³ | | | |
| Test 5 | 0.08 Mpa/ | 0.075 Mpa/ | 8 | m/min | Dry |
| | 10.2 m³ | 10.2 m³ | | | |
| Test 6 | 0.08 Mpa/ | 0.075 Mpa/ | 8 | m/min | Dry |
| | 10.2 m³ | 10.2 m³ | | | |

Various modifications and variations can be made the embodiments described herein without departing from the scope of the claimed subject matter. Thus, it is intended that the specification cover the modifications and variations of the various embodiments described herein provided such modifications and variations come within the scope of the appended claims and their equivalents.

1. A method of drying a moving sheet of material, comprising:
conveying the sheet of material adjacent an air knife in a conveyance direction;
supplying the air knife with a drying gas, the drying gas exiting an exhaust slot of the air knife in a direction toward the sheet of material, the exhaust slot comprising a length; and
wherein a pressure drop between an inlet to the air knife and the exhaust slot of the air knife is less than 90.6 kPa and a velocity of the drying gas exiting the air knife over the length of the exhaust slot does not vary over the length of the exhaust slot by more than 1% from an average velocity of the drying gas exiting the exhaust slot.

2. The method according to claim 1, wherein the velocity of the drying gas exiting the air knife over the length of the exhaust slot does not vary over the length of the exhaust slot by more than 0.4% from the average velocity of the drying gas exiting the exhaust slot.

3. The method according to claim 1, wherein an angle between a longitudinal axis of the air knife and the conveyance direction is in a range from about 65° to about 75°.

4. The method according to claim 3, wherein the air knife comprises a tip portion including an exit face comprising the exhaust slot, the tip portion comprising converging exterior side surfaces intersecting the exit face, and an angle between the converging exterior side surfaces is less than 90 degrees.

5. The method according to claim 4, wherein a width of the exit face in a direction orthogonal to the longitudinal axis of the air knife is less than 10 times a width of the exhaust slot.

6. The method according to claim 4, wherein a distance between the exit face and a proximate surface of the sheet of material is in a range from about 1 millimeters to about 10 millimeters.

7. The method according to claim 1, wherein a conveyance speed of the sheet of material is at least 8 meters/minute.

8. The method according to claim 1, wherein a length of the exhaust slot is equal to or greater than 3.5 meters.

9. An air knife, comprising:
a main body comprising:
an inlet portion comprising a plenum;
an outlet portion comprising an exit orifice in fluid communication with the plenum; and
wherein a plurality of inlet ports project from the inlet portion, each inlet port of the plurality of inlet ports comprising a passageway in fluid communication with the plenum.

10. The air knife of claim 9, wherein the inlet portion comprises a trailing wall, and each inlet port of the plurality of inlet ports projects from the trailing wall.

11. The air knife of claim 10, wherein the plenum comprises an upstream side opposite a downstream side, and the trailing wall borders the upstream side.

12. The air knife of claim 10, wherein the plurality of inlet ports project from a surface of the trailing wall, and further wherein the surface is planar.

13. The air knife of claim 10, wherein the trailing wall defines a length equal to a length of the exit orifice, and further wherein the plurality of inlet ports are aligned with and spaced apart from one another along the length of the trailing wall.

14. The air knife of claim 9, wherein the outlet portion comprises:
a channel region comprising a channel in fluid communication with and extending downstream from the plenum; and
a tip region extending from the channel region to an exit face, the exit orifice defined in the exit face,
wherein an exterior surface of the tip region comprises first and second side faces defining a taper angle therebetween less than 90 degrees.

15. The air knife of claim 14, wherein the exit orifice is an elongated slot, and a length of each of the first and second side faces is greater than a length of the elongated slot.

16. The air knife of claim 9, wherein the outlet portion comprises:
a channel region comprising a channel extending downstream from and in fluid communication with the plenum and the exit orifice, and
wherein a minor dimension of the channel is less than a minor dimension of the plenum.

17. The air knife of claim 16, wherein the minor dimension of the channel is a diameter of the channel and the minor dimension of the plenum is a depth of the plenum.

18. The air knife of claim 16, wherein the exit orifice is an elongated slot comprising a width and a length greater than the width, and the minor dimension of the channel is greater the width of the elongated slot.

19. The air knife of claim 18, wherein the outlet portion further comprises a tip region extending from the channel region to an exit face, the exit orifice defined in the exit face, and a centerline of the channel is perpendicular to a plane of the exit face, and a centerline of the plenum is perpendicular to the centerline of the channel.

20. The air knife of claim 16, wherein the outlet portion further defines a secondary chamber in fluid communication with the plenum and the channel, a minor dimension of the secondary chamber is less than the minor dimension of the plenum, and the minor dimension of the secondary chamber is greater than the minor dimension of the channel.

21. An apparatus for drying a sheet of material, the apparatus comprising:
a conveyance device establishing a path of travel for the sheet of material;
a supply of gas; and
an air knife comprising:
a main body comprising:
an inlet portion defining a plenum,
an outlet portion defining an exit orifice in fluid communication with the plenum, and
a plurality of inlet ports projecting from the inlet portion, each inlet port of the plurality of inlet ports defining a passageway in fluid communication with the plenum;
wherein the plurality of inlet ports are in fluid communication with the supply of gas; and
wherein the exit orifice is arranged adjacent the path of travel to discharge a stream of gas received from the supply of gas onto a surface of the sheet of material conveyed by the conveyance device.

22. The apparatus of claim 21, wherein the inlet portion comprises a trailing wall defining an upstream side of the plenum, the upstream side being opposite a downstream side of the plenum, and further wherein each inlet port of the plurality of inlet ports projects from the trailing wall.

23. The apparatus of claim 21, wherein the outlet portion comprises:
a channel region defining a channel in fluid communication with and extending downstream from the plenum; and
a tip region extending from the channel region to an exit face, the exit orifice defined in the exit face;
wherein an exterior surface of the tip region comprises first and second side faces intersecting opposing edges of the exit face, respectively; and
wherein the first and second side faces combine to define a taper angle less than 90 degrees in extension to the exit face.

24. The apparatus of claim 21, wherein the outlet portion comprises:
a secondary chamber in fluid communication with the plenum, wherein a minor dimension of the secondary chamber is less than a minor dimension of the plenum; and
a channel in fluid communication with the secondary chamber and the exit orifice, the channel extending downstream from the secondary chamber, wherein a minor dimension of the channel is less than the minor dimension of the plenum.

25.-28. (canceled)
